(19) United States
(12) Patent Application Publication
(10) Pub. No.: US 2023/0339220 A1
(43) Pub. Date: Oct. 26, 2023

(54) FULL FOIL FACE ASSEMBLIES AND METHODS FOR MANUFACTURING THE SAME

(71) Applicant: Illinois Tool Works Inc., Glenview, IL (US)

(72) Inventors: Daniel Szumski, Saint John, IN (US); Kenneth Bode, Philadelphia, PA (US)

(73) Assignee: Illinois Tool Works Inc., Glenview, IL (US)

(21) Appl. No.: 18/298,189

(22) Filed: Apr. 10, 2023

Related U.S. Application Data
(60) Provisional application No. 63/363,392, filed on Apr. 22, 2022.

(51) Int. Cl. B32B 27/08

(52) U.S. Cl. CPC B32B 27/08; B32B 2425/00; B32B 2307/7376; B32B 2307/40; B32B 2250/24; B32B 2307/202

(57) ABSTRACT

Full foil face assemblies and methods for manufacturing the same are provided. The assemblies can be formed by obtaining a first film layer having a maximum thickness that is no greater than 2.0 mils, and applying the first film layer with a reflective or refractive body-containing layer to form a core layer assembly. The reflective or refractive body-containing layer may provide a functional feature and/or decorative feature of a card to be manufactured using the first film layer and the core layer assembly.

### CROSS-REFERENCE TO RELATED APPLICATIONS

This application claims priority to U.S. Provisional Patent Application No. 63/363,392, which was filed on 22-Apr.-2022, and the entire disclosure of which is incorporated herein by reference.

### BACKGROUND

### Technical Field

The subject matter described herein relates to laminated sheets and cards that are at least partially manufactured from these sheets.

### State of The Art

Laminated sheets and cards are used in a variety of applications, such as financial transaction cards (e.g., credit or debit cards, phone cards, gift cards, loyalty cards, etc.), security cards (e.g., identification cards), and the like. Some known sheets and cards may be formed from multiple layers of plastic based substrates, holographic, metallized, printed or clear films or foils, adhesives and coatings, among other layers. The cards also may include printing, graphics, and/or other features.

Some cards are full face foil cards sold with a front and back. One example of such cards are ones that use HoloLam Plus®, an ITW product. Many of these cards are made with a clear polyethylene terephthalate (PET) film that usually provides no aesthetic or security benefit or functionality to the card. The finished card construction for some cards is approximately 90% polyvinyl chloride (PVC) and at least 10% PET.

The construction of some known cards may include two layers of PET film required to be equidistant from a center of the card to produce a balanced card. The back PET layers of these balanced cards tend to be clear, and are an added cost for the card manufacturer as the back layers tend to be more expensive than using PVC and have higher scrap than processing PVC.

Thus, a need may exist for film layers used in cards, the cards themselves, and methods for manufacturing the film layers and/or the cards that avoids wasteful use of the back PET layer.

### BRIEF DESCRIPTION

In one embodiment a method is provided that includes obtaining a first film layer having a maximum thickness that is no greater than 2.0 mils, and applying the first film layer with a reflective or refractive body-containing layer to form a core layer assembly. The reflective or refractive body-containing layer may provide one or more of a functional feature or decorative feature of a card to be manufactured using the first film layer and the core layer assembly.

In one embodiment, a method is provided that include obtaining a first polymer web having a manufactured width, and cutting a first film layer from a center section of the first polymer web. The method can also include combining the first polymer layer with a conductive body-containing layer to form a core layer assembly. The conductive body-containing layer can provide one or more of a functional feature or decorative feature of a card to be manufactured using the first polymer layer and the core layer assembly.

In one embodiment, a method is provided that includes obtaining a front core layer assembly having a first film layer with polymer grains oriented in a first direction and a conductive body-containing layer. The method also includes obtaining a second film layer with polymer grains oriented in a transverse direction, and combining the front core layer assembly with the first film layer to at least partially form a card having one or more of a functional feature or a decorative feature provided by the conductive body-containing layer. The front core layer assembly and the first film layer may combine with the first direction of the polymer grains in the second film layer oriented to the transverse direction of the polymer grains in the first film layer.

In one embodiment, a card is provided that includes a front split core layer assembly having a first film layer and a conductive body-containing layer that provides one or more of a functional feature or a decorative feature of the card, the front split core layer assembly configured to have card information printed thereon. The card can also include a back split core layer assembly having a second film layer, and a front overlay layer disposed on the front split core layer assembly. The card may also include a back overlay layer disposed beneath the back split core layer assembly. The first film layer can have a maximum thickness of no more than 2.0 mils, or 92 gauge, and the back split core layer assembly may not include any of the first film layer.

### BRIEF DESCRIPTION OF THE DRAWINGS

The present inventive subject matter will be better understood from reading the following description of non-limiting embodiments, with reference to the attached drawings (which are not necessarily drawn to scale), wherein below:

FIG. 1 illustrates a schematic diagram of a card, according to one embodiment;

FIG. 2 illustrates a cross-sectional view of the card of FIG. 1 along line 2-2 in FIG. 1, according to one embodiment;

FIG. 3 illustrates a perspective view of films orientation during a manufacturing process, according to one embodiment;

FIG. 4 illustrates a portion of a system to create a film layer, according to one embodiment;

FIG. 5 illustrates a block flow diagram of a method for manufacturing a card, according to one embodiment.

### DETAILED DESCRIPTION

A card and a method for manufacturing the same is provided that reduces materials of the card to decrease expenses. The card includes a first film layer that can be made of a polyethylene terephthalate (PET) material that has a maximum thickness that is no greater than 2.0 mils. In addition, during manufacturing, processes are undertaken to reduce stresses on layers and generated between layers. As an example, only a center-cut of a polymer web is utilized for the first film layer. In addition, the first film layer and a reflective or refractive body-containing layer are oriented transverse to a second film layer that can be made of a polyvinyl chloride (PVC) material. The transverse orientation reduces stresses between the layers when they are combined. By reducing the size of the first film layer, and by reducing the stresses within the layers of the card, an additional film layer that includes a PET material is unnecessary for balancing the card to reduce stress. By eliminating this unnecessary material, costs are saved during the manufacturing process.

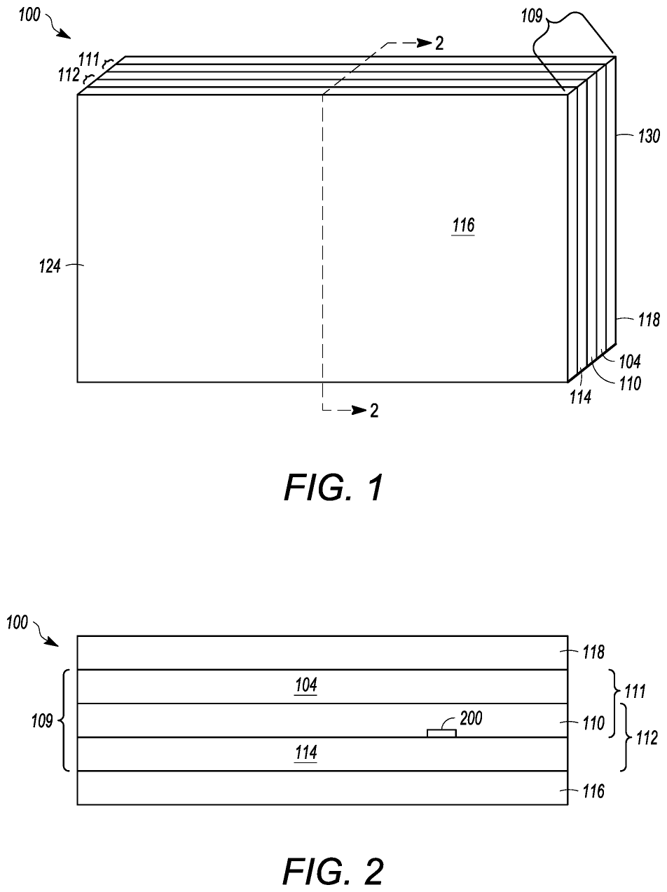

FIG. 1 is a schematic diagram of a laminated card 100 formed in accordance with one or more embodiments of the subject matter described herein. FIG. 2 is a cross-sectional view of the card 100 along line 2-2 in FIG. 1. The card 100 may be used in a variety of applications, such as a financial transaction card (e.g., credit or debit card, phone card, gift card, loyalty card, etc.), a security card (e.g., identification card), and the like. The card 100 includes a visible surface or side 124 on which information may be printed or otherwise shown. For example, the surface or side 124 may include printed text, numbers, images, and the like, that indicate a use of the card 100, an owner of the card 100, an institution that issued and/or accepts the card 100, or the like.

The card 100 is formed from several planar sections of films, sheets, etc. that are laminated together. These planar sheet sections include a first film layer 104 on the front side 106 of the card 100. The first film layer 104 may be formed from one or more of polyethylene terephthalate (PET), amorphous polyethylene terephthalate (APET), polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), co-extruded polymer films, or the like.

In one example, the first film layer 104 is formed to have the maximum thickness that is no greater than 0.18 mils. In another example, the maximum thickness of the first film layer is no greater than 2.0 mils. By having a maximum thickness that is no greater than 0.18 mils or 2.0 mils, the stresses caused between the first film layer and other layers is reduced. As a result, a backside side film layer at a back side 108 of the card 100 that only provides the function of balancing forces created by the first film layer can be eliminated.

The first film layer 104 combines with a reflective or refractive body-containing layer 110 to form a core layer assembly 109. The reflective or refractive body-containing layer 110 in one example can include one or more functional features or decorative features 200 of a card. In an example, the functional feature may be radio frequency identification (RFID) circuitry, an RFID antenna, or the like, while the decorative feature may be artwork, a shape, picture, words, card information, printed words or card information, or the like. To this end, in an example embodiment, the reflective or refractive body-containing layer 110 can be conductive. Alternatively, the body-containing layer 110 may be nonconductive. In addition, the body-containing layer 110 may be clear, opaque, colored, etc.

The core layer assembly 109 in one example may be a front split core layer assembly 111 of the card 100 where the first film layer 104 is combined with the reflective or refractive body-containing layer 110. In addition, the card can also include a back split core layer assembly 112 that is formed from the body-containing layer and a second film layer 114. In one example the second film layer 114 can have a minimum thickness of at least 4.00 mils. The second film layer 114 can also include one or more of a PVC, a PVC copolymer, a PVC homopolymer, recycled PVC, a PET, an APET, a PETG, a PC, a PS, acrylonitrile butadiene styrene polymer (ABS), a PBT, an acrylic, a polymer formed from polyethylene (PE) and polypropylene (PP), high impact polystyrene (HIPS), paper, board stock, etc.

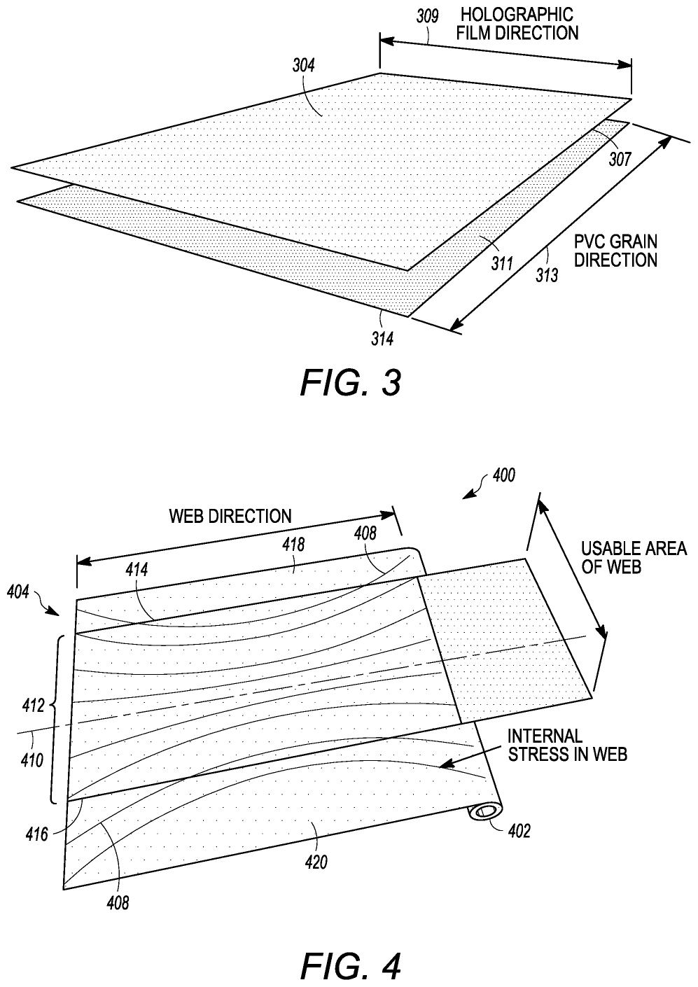

In one example as illustrated in FIG. 3, during the manufacturing process, a first film layer 304 may be formed with polymer grains 307 that are oriented along a first grain direction 309 that is transverse to polymer grains 311 that are oriented along a second grain direction 313 that are on the second film layer 314. By having the polymer grains 307 of the first film layer 304 transverse to the polymer grains 311 of the second film layer 314, stresses between the layers are reduced. In this manner, when the first film layer 304 is formed from a PET material, and the second film layer 314 is formed of a PVC material, an additional layer of PET material on the other side of the second film layer 314 is unneeded to balance forces and to reduce stress in the card 100.

With reference back to FIGS. 1 and 2, the card 100 may also include additional overlay layers 116, 118 that can be added to the core layer assembly 109. For example, a front overlay layer 116 can be disposed on the front split core layer assembly 111 to provide additional protection for the card. Similarly, a back overlay layer 116 can be disposed beneath the back split core layer assembly 112 again to provide additional protection. In this manner, The overlay layers 116, 118 may be placed onto the corresponding sides 124, 130 of the core layer assembly 109 to protect the information printed on the body-containing layer 110. In yet another example, as illustrated in FIG. 2 the core layer assembly 109 can also include be a center core layer assembly that includes one or more electronic components 200. The electronic components 200 may be a RFID antenna, circuitry, protection circuitry, wireless circuitry, or the like.

In one example, when conductive bodies or materials are used within the card, the conductive bodies can be arranged so that a conductive pathway between two or more edges of the card 100 does not exist. For example, even though the conductive body of bodies may extend across all or predominantly all of a planar surface of the core layer assembly 109, the conductive body or bodies may not form a conductive pathway that extends from one edge of the card 100 to another edge of the card 100. The edges extend from one side or surface of the card 100 to the opposite side or surface of the card 100. The lack of such a conductive pathway allows for the card 100 to include the reflective or refractive body-containing layer 110 layer for decorating the card, verifying the authenticity of the card, or the like, while avoiding discharge of electric static discharge from the card 100. In this manner, the reflective or refractive body-containing layer 110 provides one or more of a functional feature or decorative feature of a card 100.

FIG. 4 is schematic diagram of a portion of a system 400 used to create the first film layer 104 shown in FIGS. 1-2 in accordance with one embodiment. The system 400 includes an unwind roller 402 that may have a continuous first polymer web 404 having a manufactured width. By “continuous,” it is meant that the web 404 extends for a longer length than may be needed to form the portion of the first film layer 104. For example, the first polymer web 404 may be moved in a processing direction through the system 400. The web 404 has a length along this processing direction that is longer than the length of the first film layer 104.

In one example, the width of the polymer web 404 may be 240 inches, whereas when the first film layer 104 is processed, only 60 inches is utilized. During processing, the polymer web includes internal stresses 408 that increase the further away from the center-line 410 of the polymer web 404. During processing, the center-cut, or center section 412 is processed resulting in a first film layer 104 having web edges 414, 416 and a first outer section 418 and second outer section 420 that may be discarded. By processing the center section 412, stresses of the first film layer 104 are reduced, including stressed between the first film layer 104 within the core layer assembly 109. Because of the reduced stresses, a third, or counter balancing film layer made of PET is no longer needed on the opposite side of the card from the first film layer, reducing manufacturing costs.

In another example, the first film layer may be made from the web 404 and formed with polymer grains oriented along a first grain direction that is transverse to a second grain direction in which polymer grains of a second film layer in the card are oriented. Forming the first film layer may also include cutting the first film layer 104 from the web 404 where the first film layer is from the center section 412. The first film layer 104 is not cut from other sections of the web, including the outer sections 418 and 420.

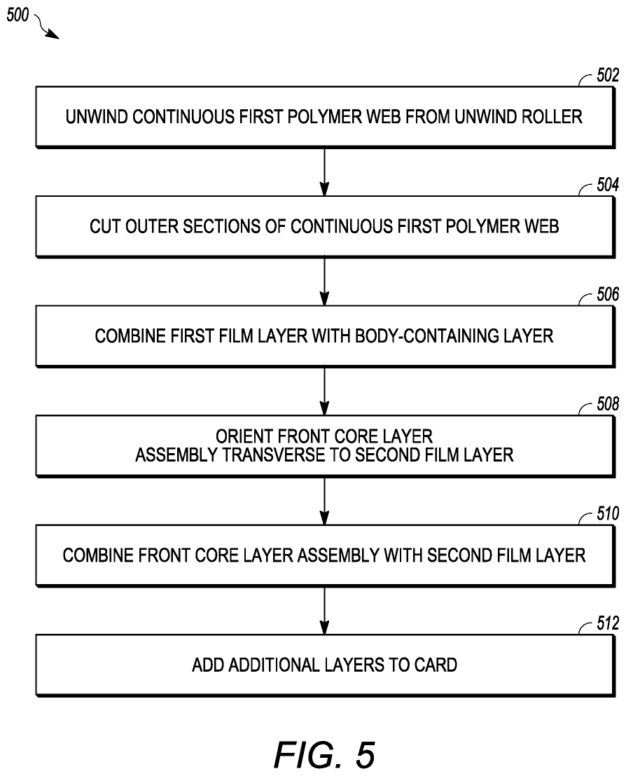

FIG. 5 illustrates a flowchart of a method 500 for manufacturing cards in accordance with one embodiment. The method 500 may be used to create one or more of the cards described herein.

At 502, a continuous first polymer web having a manufactured width is unwound from an unwind roller. The continuous web may be formed from PET or APET. In another example, the continuous web is formed from one or more of PETG, PBT, OPP, another olefin, PVC, an acrylic, HIPS, PS, PC, co-extruded polymer films, or the like. The continuous web may have the maximum thickness that is no greater than 0.18 mils. In another example, the continuous polymer web may have a maximum thickness that is not greater than 2.0 mils. In yet another example, the web is manufactured to have a width of 240″. Along the web is a center section having opposite outer sections on either side. In one example, a first outer section is 90″ while the opposite second outer section is 90″, and the center section is 60″. In particular, the center section 60″ has the least amount of stress, and less than the stress of both the first outer section and second outer section.

At 504, the continuous web is cut to remove the first outer section and the second outer section to form a first film layer from the polymer web. In particular, the center section of the polymer web is the section of the polymer web with the least amount of stress. Thus, by cutting the first film layer from the center section of the first polymer web instead of an outer section, stresses on the first film layer are reduced, allowing a card to be manufactured that does not require an addition film layer cut from the polymer web material.

At 506, the first film layer can be coupled, or combined to a reflective or refractive body-containing layer. In one example, combining the first film layer and the reflective or refractive body-containing layer forms a front core layer assembly. In one example the body-containing layer can be a conductive body-containing layer. The body-containing layer may include a RFID antenna, wireless communication circuitry, etc. to provide a functional feature for the card. In another example the body-containing layer may include a decorative feature such as a drawing, term, saying, picture, artwork, printed card information, or the like.

At 508, the front core layer assembly is oriented transverse to a second film layer. By placing the front core layer assembly transverse to the second film layer, the grains of each layer are oriented transversely, resulting in reduced stresses between the two layers when the layers are combined.

At 510, the front core layer assembly is coupled or combined with a second film layer to form a core layer assembly. In one embodiment the core layer assembly can include a split core front layer assembly of the card, and when the second film layer is combined with the body-containing layer, a split core back layer assembly is formed. In particular, in an example embodiment, additional layers may be included in the split core back layer assembly depending on the desired thickness of the card or desire for extra protection. In one example the second film layer can have a minimum thickness of at least 4.00 mils. In one example, the second film layer can include one or more of PVC, a PVC copolymer, a PVC homopolymer, recycled PVC, recycled PET, PET, APET, PETG, PC, PS, ABS, PBT, an acrylic, a polymer formed from PE and PP, HIPS, paper, board stock, or the like. In this manner, the PET first film layer can be combined with additional layers (e.g. body-containing layer, second film layer, etc.) made from PVC without needing an additional PET layer. Consequently material costs are reduced, and cost savings realized.

At 512, additional layers may be added to the card. In one example a front overlay layer may be disposed on the front split core layer assembly. A front overlay layer can be added to provide additional width, protection, etc. for the card. In another example, a back overlay layer can be disposed beneath the back split core layer assembly. Again, the additional layer may be added for additional protection for the card. In yet another example, a center core layer may be added that can include electronic components such as an RFID antenna, wireless circuitry, or the like for additional functionality. Still, by reducing the size of the first film layer that can be made form a PET material, additional material does not have to be added to the card to address stresses on the card. As a result, manufacturing cost and materials are saved, and an improved method provided.

In one embodiment a method is provided that includes obtaining a first film layer having a maximum thickness that is no greater than 2.0 mils, and applying the first film layer with a reflective or refractive body-containing layer to form a core layer assembly. The reflective or refractive body-containing layer may provide one or more of a functional feature or decorative feature of a card to be manufactured using the first film layer and the core layer assembly.

Optionally, the first film layer is formed from one or more of polyethylene terephthalate (PET) or amorphous polyethylene terephthalate (APET).

Optionally, the first film layer is formed from one or more of polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), or co-extruded polymer films.

Optionally, the first film layer is formed to have the minimum thickness that is no less than 0.18 mils.

Optionally, the core layer assembly is a split core front layer assembly of the card, and the first film layer is combined with the reflective or refractive body-containing layer for inclusion in the card having a split core back layer assembly formed from a second film layer having a minimum thickness of at least 4.00 mils.

Optionally, the second film layer includes one or more of a polyvinyl chloride (PVC), a PVC copolymer, a PVC homopolymer, recycled PVC, polyethylene terephthalate (PET), amorphous polyethylene terephthalate (APET), polyethylene terephthalate (PETG), polycarbonate (PC), polystyrene (PS), acrylonitrile butadiene styrene polymer (ABS), polybutylene terephthalate (PBT), an acrylic, a polymer formed from polyethylene (PE) and polypropylene (PP), high impact polystyrene (HIPS), paper, or board stock.

Optionally, the first film layer is formed with polymer grains oriented along a first grain direction that is transverse to a second grain direction in which polymer grains of a second film layer in the card are oriented.

Optionally, forming the first polymer layer includes cutting the first polymer layer from the first polymer web with the first polymer layer cut from a center section of the first polymer web.

Optionally, the first polymer web includes the center section and opposite outer sections, and the first polymer layer is cut from the center section and not either of the outer sections of the first polymer web.

Optionally, the body-containing layer is conductive.

Optionally, the body-containing layer is non-conductive.

Optionally, the body-containing layer is not clear.

In one embodiment, a method is provided that include obtaining a first polymer web having a manufactured width, and cutting a first film layer from a center section of the first polymer web. The method can also include combining the first polymer layer with a conductive body-containing layer to form a core layer assembly. The conductive body-containing layer can provide one or more of a functional feature or decorative feature of a card to be manufactured using the first polymer layer and the core layer assembly.

Optionally, the first film layer is formed from one or more of polyethylene terephthalate (PET) or amorphous polyethylene terephthalate (APET).

Optionally, the first film layer is formed from one or more of polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), or co-extruded polymer films.

Optionally, the first polymer web includes the center section and opposite outer sections, and the first polymer layer is cut from the center section and not either of the outer sections of the first polymer web.

Optionally, the first polymer web is extruded with a maximum thickness that is no greater than 2.0 mils.

Optionally, the core layer assembly is a split core front layer assembly of the card, and the first polymer layer is combined with the conductive body-containing layer for inclusion in the card having a split core back layer assembly formed from a second film layer having a minimum thickness of at least 4.00 mils.

Optionally, the second film layer includes one or more of a polyvinyl chloride (PVC), a PVC copolymer, a PVC homopolymer, PVC, polyethylene terephthalate (PET), amorphous polyethylene terephthalate (APET), polyethylene terephthalate (PETG), polycarbonate (PC), polystyrene (PS), acrylonitrile butadiene styrene polymer (ABS), polybutylene terephthalate (PBT), an acrylic, a polymer formed from polyethylene (PE) and polypropylene (PP), high impact polystyrene (HIPS), and all recycled versions of such plastics, paper, or board stock.

Optionally, the first polymer web and the first film layer are formed with polymer grains oriented along a first grain direction that is transverse to a second grain direction in which polymer grains of a second film layer in the card are oriented.

In one embodiment, a method is provided that includes obtaining a front core layer assembly having a first film layer with polymer grains oriented in a first direction and a conductive body-containing layer. The method also includes obtaining a second film layer with polymer grains oriented in a transverse direction, and combining the front core layer assembly with the first film layer to at least partially form a card having one or more of a functional feature or a decorative feature provided by the conductive body-containing layer. The front core layer assembly and the first film layer may combine with the first direction of the polymer grains in the second film layer oriented to the transverse direction of the polymer grains in the first film layer.

Optionally, a maximum thickness of the first film layer is no greater than 2.0 mils.

Optionally, a minimum thickness of the first film layer is no less than 0.18 mils.

Optionally, the second film layer has a minimum thickness of at least 4.00 mils.

Optionally, the first film layer is formed from one or more of polyethylene terephthalate (PET), amorphous polyethylene terephthalate (APET), polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), co-extruded polymer films, and all recycled versions of such plastics.

Optionally, the second film layer includes one or more of a polyvinyl chloride (PVC), a PVC copolymer, a PVC homopolymer, recycled PVC, polyethylene terephthalate (PET), amorphous polyethylene terephthalate (APET), polyethylene terephthalate (PETG), polycarbonate (PC), polystyrene (PS), acrylonitrile butadiene styrene polymer (ABS), polybutylene terephthalate (PBT), an acrylic, a polymer formed from polyethylene (PE) and polypropylene (PP), high impact polystyrene (HIPS), and all recycled versions of such plastics, paper, or board stock.

In one embodiment, a card is provided that includes a front split core layer assembly having a first film layer and a conductive body-containing layer that provides one or more of a functional feature or a decorative feature of the card, the front split core layer assembly configured to have card information printed thereon. The card can also include a back split core layer assembly having a second film layer, and a front overlay layer disposed on the front split core layer assembly. The card may also include a back overlay layer disposed beneath the back split core layer assembly. The first film layer can have a maximum thickness of no more than 2.0 mils and the back split core layer assembly may not include any of the first film layer.

Optionally, the card may also include a center core layer assembly for an RFID antennae.

Optionally, the first film layer has the minimum thickness that is no less than 0.18 mils.

Optionally, the second film layer has a minimum thickness of at least 4.00 mils.

Optionally, the first film layer has polymer grains oriented along a first grain direction that is transverse to a second grain direction in which polymer grains of the second film layer in the card are oriented.

Optionally, the first film layer is formed from one or more of polyethylene terephthalate (PET), amorphous polyethylene terephthalate (APET), polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), co-extruded polymer films, and all recycled versions of such plastics.

Optionally, the second film layer includes one or more of a polyvinyl chloride (PVC), a PVC copolymer, a PVC homopolymer, recycled PVC, polyethylene terephthalate (PET), amorphous polyethylene terephthalate (APET), polyethylene terephthalate (PETG), polycarbonate (PC), polystyrene (PS), acrylonitrile butadiene styrene polymer (ABS), polybutylene terephthalate (PBT), an acrylic, a polymer formed from polyethylene (PE) and polypropylene (PP), high impact polystyrene (HIPS), and all recycled versions of such plastics, paper, or board stock.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure. For example, the recitation of a “mechanism for,” “module for,” “device for,” “unit for,” “component for,” “element for,” “member for,” “apparatus for,” “machine for,” or “system for” is not to be interpreted as invoking 35 U.S.C. § 112(f), and any claim that recites one or more of these terms is not to be interpreted as a means-plus-function claim.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A method comprising:
obtaining a first film layer having a maximum thickness that is no greater than 2.0 mils; and
applying the first film layer with a reflective or refractive body-containing layer to form a core layer assembly, the reflective or refractive body-containing layer providing one or more of a functional feature or decorative feature of a card to be manufactured using the first film layer and the core layer assembly.

2. The method of claim 1, wherein the first film layer is formed from one or more of polyethylene terephthalate (PET), recycled (PET), or amorphous polyethylene terephthalate (APET).

3. The method of claim 1, wherein the first film layer is formed from one or more of polyethylene terephthalate (PETG), polybutylene terephthalate (PBT), oriented polypropylene (OPP), another olefin, polyvinyl chloride (PVC), an acrylic, high impact polystyrene (HIPS), polystyrene (PS), polycarbonate (PC), co-extruded polymer films, recycled PETG, recycled PBT, recycled OPP, recycled olefin, recycled PVC, recycled acrylic, recycled HIPS, recycled PS, or recycled PC.

4. The method of claim 1, wherein the first film layer is formed to have the minimum thickness that is no less than 0.18 mils.

5. The method of claim 1, wherein the core layer assembly is a split core front layer assembly of the card, and the first film layer is combined with the reflective or refractive body-containing layer for inclusion in the card having a split core back layer assembly formed from a second film layer having a minimum thickness of at least 4.00 mils.

6. The method of claim 5, wherein the second film layer includes one or more of a polyvinyl chloride (PVC), a PVC copolymer, a PVC homopolymer, recycled PVC, polyethylene terephthalate (PET), recycled PET, amorphous polyethylene terephthalate (APET), recycled APET, polyethylene terephthalate (PETG), recycled PETG, polycarbonate (PC), recycled PC, polystyrene (PS), recycled PS, acrylonitrile butadiene styrene polymer (ABS), recycled ABS, polybutylene terephthalate (PBT), recycled PBT, an acrylic, a recycled acrylic, a polymer formed from polyethylene (PE) and polypropylene (PP), a recycled polymer formed from PE and PP, high impact polystyrene (HIPS), recycled HIPS, paper, or board stock.

7. The method of claim 1, wherein the first film layer is formed with polymer grains oriented along a first grain direction that is transverse to a second grain direction in which polymer grains of a second film layer in the card are oriented.

8. The method of claim 1, wherein forming the first polymer layer includes cutting the first polymer layer from the first polymer web with the first polymer layer cut from a center section of the first polymer web.

9. The method of claim 8, wherein the first polymer web includes the center section and opposite outer sections, and the first polymer layer is cut from the center section and not either of the outer sections of the first polymer web.

10. The method of claim 1, wherein the body-containing layer is conductive.

11. The method of claim 1, wherein the body-containing layer is non-conductive.

12. The method of claim 1, wherein the body-containing layer is not clear.

13. A method comprising:
obtaining a first polymer web having a manufactured width;
cutting a first film layer from a center section of the first polymer web; and
combining the first film layer with a conductive body-containing layer to form a core layer assembly, the conductive body-containing layer providing one or more of a functional feature or decorative feature of a card to be manufactured using the first film layer and the core layer assembly.

14. The method of claim 13, wherein the first film layer is formed from one or more of polyethylene terephthalate (PET), recycled PET, amorphous polyethylene terephthalate (APET), or recycled APET.

15. The method of claim 13, wherein the first film layer is formed from one or more of polyethylene terephthalate (PETG), recycled PETG, polybutylene terephthalate (PBT), recycled PBT, oriented polypropylene (OPP), recycled OPP, another olefin, a recycled olefin, polyvinyl chloride (PVC), recycled PVC, an acrylic, recycled acrylic, high impact polystyrene (HIPS), recycled HIPS, polystyrene (PS), recycled PS, polycarbonate (PC), recycled PC, or co-extruded polymer films.

16. The method of claim 13, wherein the first polymer web includes the center section and opposite outer sections, and the first polymer layer is cut from the center section and not either of the outer sections of the first polymer web.

17. The method of claim 13, wherein the first polymer web is extruded with a maximum thickness that is no greater than 2.0 mils.

18. The method of claim 13, wherein the core layer assembly is a split core front layer assembly of the card, and the first polymer layer is combined with the conductive body-containing layer for inclusion in the card having a split core back layer assembly formed from a second film layer having a minimum thickness of at least 4.00 mils.

19. The method of claim 18, wherein the second film layer includes one or more of a polyvinyl chloride (PVC), a PVC copolymer, a PVC homopolymer, recycled PVC, polyethylene terephthalate (PET), recycled PET, amorphous polyethylene terephthalate (APET), recycled APET, polyethylene terephthalate (PETG), recycled PETG, polycarbonate (PC), recycled PC, polystyrene (PS), recycled PS, acrylonitrile butadiene styrene polymer (ABS), recycled ABS, polybutylene terephthalate (PBT), recycled PBT, an acrylic, a recycled acrylic, a polymer formed from polyethylene (PE) and polypropylene (PP), a recycled polymer formed from PE and PP, high impact polystyrene (HIPS), recycled HIPS, paper, or board stock.

20. The method of claim 13, wherein the first polymer web and the first film layer are formed with polymer grains oriented along a first grain direction that is transverse to a second grain direction in which polymer grains of a second film layer in the card are oriented.

21. A method comprising:
obtaining a front core layer assembly having a first film layer with polymer grains oriented in a first direction and a conductive body-containing layer;
obtaining a second film layer with polymer grains oriented in a transverse direction; and
combining the front core layer assembly with the first film layer to at least partially form a card having one or more of a functional feature or a decorative feature provided by the conductive body-containing layer, the front core layer assembly and the first film layer combined with the first direction of the polymer grains in the second film layer oriented to the transverse direction of the polymer grains in the first film layer.

22. The method of claim 21, wherein a maximum thickness of the first film layer is no greater than 2.0 mils.

23. The method of claim 21, wherein a minimum thickness of the first film layer is no less than 0.18 mils.

24. The method of claim 21, wherein the second film layer has a minimum thickness of at least 4.00 mils.

25. The method of claim 21, wherein the first film layer is formed from one or more of polyethylene terephthalate (PET), a recycled PET, amorphous polyethylene terephthalate (APET), a recycled PET, polyethylene terephthalate (PETG), a recycled PETG, polybutylene terephthalate (PBT), a recycled PBT, oriented polypropylene (OPP), recycled OPP, another olefin, recycled olefin, polyvinyl chloride (PVC), recycled PVC, an acrylic, recycled acrylic, high impact polystyrene (HIPS), recycled HIPS, polystyrene (PS), recycled PS, polycarbonate (PC), recycled PC, or co-extruded polymer films.

26. The method of claim 21, wherein the second film layer includes one or more of a polyvinyl chloride (PVC), a PVC copolymer, a PVC homopolymer, recycled PVC, polyethylene terephthalate (PET), recycled PET, amorphous polyethylene terephthalate (APET), recycled APET, polyethylene terephthalate (PETG), recycled PETG, polycarbonate (PC), recycled PC, polystyrene (PS), recycled PS, acrylonitrile butadiene styrene polymer (ABS), recycled ABS, polybutylene terephthalate (PBT), recycled PBT, an acrylic, a recycled acrylic, a polymer formed from polyethylene (PE) and polypropylene (PP), a recycled polymer formed from PE and PP, high impact polystyrene (HIPS), recycled HIPS, paper, or board stock.

27. A card comprising:
a front split core layer assembly having a first film layer and a conductive body-containing layer that provides one or more of a functional feature or a decorative feature of the card, the front split core layer assembly configured to have card information printed thereon;
a back split core layer assembly having a second film layer;
a front overlay layer disposed on the front split core layer assembly; and
a back overlay layer disposed beneath the back split core layer assembly,
wherein the first film layer has a maximum thickness of no more than 2.0 mils and the back split core layer assembly does not include any of the first film layer.

28. The card of claim 27, further comprising:
a center core layer assembly for RFID antennae.

29. The card of claim 27, wherein the first film layer has the minimum thickness that is no less than 0.18 mils.

30. The card of claim 27, wherein the second film layer has a minimum thickness of at least 4.00 mils.

31. The card of claim 27, wherein the first film layer has polymer grains oriented along a first grain direction that is transverse to a second grain direction in which polymer grains of the second film layer in the card are oriented.

32. The card of claim 27, wherein the first film layer is formed from one or more of polyethylene terephthalate (PET), a recycled PET, amorphous polyethylene terephthalate (APET), a recycled PET, polyethylene terephthalate (PETG), a recycled PETG, polybutylene terephthalate (PBT), a recycled PBT, oriented polypropylene (OPP), recycled OPP, another olefin, recycled olefin, polyvinyl chloride (PVC), recycled PVC, an acrylic, recycled acrylic, high impact polystyrene (HIPS), recycled HIPS, polystyrene (PS), recycled PS, polycarbonate (PC), recycled PC, or co-extruded polymer films.

33. The card of claim 27, wherein the second film layer includes one or more of a polyvinyl chloride (PVC), a PVC copolymer, a PVC homopolymer, recycled PVC, polyethylene terephthalate (PET), recycled PET, amorphous polyethylene terephthalate (APET), recycled APET, polyethylene terephthalate (PETG), recycled PETG, polycarbonate (PC), recycled PC, polystyrene (PS), recycled PS, acrylonitrile butadiene styrene polymer (ABS), recycled ABS, polybutylene terephthalate (PBT), recycled PBT, an acrylic, a recycled acrylic, a polymer formed from polyethylene (PE) and polypropylene (PP), a recycled polymer formed from PE and PP, high impact polystyrene (HIPS), recycled HIPS, paper, or board stock.
